(19) United States
(12) Patent Application Publication
(10) Pub. No.: US 2007/0131258 A1
(43) Pub. Date: Jun. 14, 2007

(54) DISHWASHER INCLUDING A FIRST DOOR AND A SECOND DOOR

(75) Inventor: Gregory E. Gault, Greenville, NC (US)

Correspondence Address: PEARNE & GORDON LLP, 1801 EAST 9TH STREET, SUITE 1200, CLEVELAND, OH, 44114-3108, US

(73) Assignee: ELECTROLUX HOME PRODUCTS, INC., Cleveland, OH (US)

(21) Appl. No.: 11/608,471

(22) Filed: Dec. 8, 2006

Related U.S. Application Data
(60) Provisional application No. 60/749,828, filed on Dec. 13, 2005.

(51) Int. Cl. B08B 3/00

(52) U.S. Cl. 134/56 D

(57) ABSTRACT

A dishwasher includes a housing at least partially defining an interior area configured to receive dishware. The interior area includes a first access opening and a second access opening. A first door is attached with respect to the housing and configured to selectively close the first access opening. A second door is attached with respect to the housing and configured to selectively close the second access opening.

### CROSS-REFERENCE TO RELATED APPLICATIONS

This application claims the benefit of U.S. Provisional Application No. 60/749,828, filed Dec. 13, 2005, the entire disclosure of which is hereby incorporated herein by reference.

### FIELD OF THE INVENTION

The present invention relates to dishwashing machines and, more particularly, to dishwashers including a first door and a second door.

### BACKGROUND OF THE INVENTION

Many workrooms, such as kitchens, include an island cabinet with an island counter surface that is positioned in a central area of the workroom. Workrooms are also known to include a peninsula cabinet with a peninsula counter surface that extends into a central area of a workroom. Still further, workrooms are known to include open windows through a wall with a counter area adjacent the lower periphery of the open window. For example, a wall may define an open window extending through the wall to permit access and viewing between the workroom and a seating area adjacent the open window. The counter surface at the lower periphery of the open window can facilitate support of articles, for example, being passed between seating area and the workroom. The counter surfaces associated with the island, peninsula and open window arrangements produce additional workspace and can also enhance the ergonomic arrangement of counter surfaces associated with the workroom.

Conventional dishwashers are commonly employed to provide automatic cleaning of dishes. Many dishwashers comprise undercounter dishwashers that are designed to fit under a counter surface against a wall of a workroom to preserve space. Such undercounter dishwashers are known to include a single door that pivots down to permit loading of dishware into the interior area of the dishwasher from a nearby wash basin, counter surface, or other area typically located above the undercounter dishwasher.

Providing a conventional undercounter dishwasher underneath the counter surface of the island, peninsula or open window arrangement may be desirable in certain workroom arrangements. However, known undercounter dishwashers include a single access opening for loading dishware into the interior area of the undercounter dishwasher.

### BRIEF SUMMARY OF THE INVENTION

Accordingly, it is an aspect of the present invention to obviate problems and shortcomings of conventional dishwashers. To achieve the foregoing and other aspects and in accordance with the present invention, a dishwasher includes a housing at least partially defining an interior area configured to receive dishware. The interior area includes a first access opening and a second access opening. A first door is pivotally attached with respect to the housing and configured to selectively close the first access opening. A second door is pivotally attached with respect to the housing and configured to selectively close the second access opening.

To achieve further aspects and in accordance with the present invention, a dishwasher includes a housing at least partially defining an interior area configured to receive dishware. The interior area includes a first access opening and a second access opening, wherein the first and second access openings are located at opposite sides of the housing. A first door is pivotally attached with respect to the housing and configured to selectively close the first access opening. A second door is pivotally attached with respect to the housing and configured to selectively close the second access opening. The first door and second door are each configured to pivot in opposite directions with respect to the housing. The dishwasher further includes at least one dishwasher rack configured to be moved between a retracted position wherein the rack is located within the interior area, and an extended position wherein at least a portion of the rack is located outside of the interior area. The portion of the rack is configured to be moved through at least one of the first and second access openings when moving the rack from the retracted position to the extended position.

To achieve still further aspects and in accordance with the present invention, a workstation includes an undercounter dishwasher with a housing at least partially defining an interior area configured to receive dishware. The interior area includes a first access opening and a second access opening. A first door is configured to selectively close the first access opening and a second door configured to selectively close the second access opening. At least one dishwasher rack is configured to be moved between a retracted position wherein the rack is located within the interior area and an extended position wherein at least a portion of the rack is located outside of the interior area. The portion of the rack is configured to be moved through at least one of the first and second access openings when moving the rack from the retracted position to the extended position. The workstation further includes a counter surface positioned above the dishwasher.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 illustrates an upper front perspective view of an example dishwasher in accordance with one embodiment of the present invention wherein a first door is positioned in a closed orientation with respect to a housing and a second door is positioned in an open orientation with respect to the housing;

FIG. 2 illustrates another upper front perspective view of the dishwasher of FIG. 1 wherein the first door is positioned in an open orientation with respect to the housing and the second door is positioned in a closed orientation with respect to the housing;

FIG. 3 illustrates an upper rear perspective view of the dishwasher of FIG. 1 wherein the first and second doors are both positioned in an open orientation with respect to the housing;

FIG. 4 illustrates an example floor layout including the dishwasher of FIG. 1 incorporated in a workstation comprising an island positioned within an area of a workroom; and

FIG. 5 illustrates another example floor layout including the dishwasher of FIG. 1 incorporated in a workstation comprising a peninsula that extends into an area of a workroom.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices.

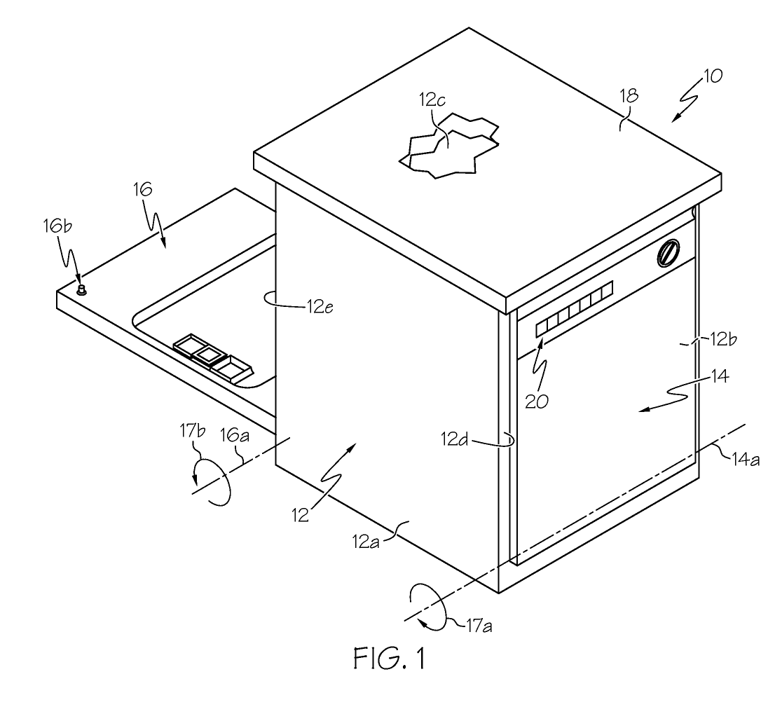

FIGS. 1-3 depict an example dishwasher 10 in accordance with one embodiment of the present invention. Portions of the illustrated dishwasher 10 are illustrated in somewhat schematic form. Dishwashers 10 in accordance with aspects of the present invention can include a housing 12. Housings may be fabricated from a wide range of materials including metals (e.g., aluminum, stainless steel), plastics (e.g., thermoplastic), composites or other types of materials using a wide range of techniques. Moreover, the housing can include a plurality of sides. For example, as shown in FIG. 1, the dishwasher 10 includes a housing 12 with a first lateral side 12a, a second lateral side 12b, an upper side 12c, front side 12d and rear side 12e. It is also contemplated that the housing 12 may include more or less sides in further examples.

The sides of the housing 12 can be finished or unfinished depending on the particular application. For example, the housing 12 can include sides that are finished in applications where the dishwasher may be used as a stand alone appliance in a workroom, such as a kitchen. In further examples, the sides of the housing may be unfinished in applications where the dishwasher is intended to be incorporated into a workstation or other construction. For instance, as shown in FIGS. 1-5, the dishwasher comprises an undercounter dishwasher wherein a counter surface (18, 118, 218) is positioned above the dishwasher 10. The counter surface 18 shown in FIG. 1 is partially broken away to illustrate the upper side 12c of the housing 12 positioned below the counter surface 18. Counter surfaces, if provided, can be fabricated from a wide variety of known materials such as wood, stainless steel, ceramic, granite, composites or other specialty materials configured to be used as a counter surface by one standing adjacent the dishwasher. Although not shown, example dishwashers can be incorporated in a wall dividing rooms of a dwelling, a cabinet structure, or other arrangement wherein a counter surface may or may not be located above the dishwasher.

The housing 12 of the dishwasher can further at least partially define an interior area 13 configured to receive dishware. For example, it is contemplated that the interior area 13 may receive dishware such as pots, pans, plates, bowls, utensils, glassware, drinking vessels (e.g., cups, mugs, glasses, stemware) or other kitchenware. The interior area 13 includes a plurality of access openings. For example, as shown, the interior area 13 includes a first access opening 13a and a second access opening 13b. In further examples, three or more access openings may be incorporated in accordance with the present invention. The plurality of access openings may be located on the same side of the housing to permit enhanced loading options along the side of the housing. In further examples, the access openings may be located at different sides of the housing. For example, one access opening may be located on a side adjacent another side of the housing. In another example, first and second access openings may be located at opposite sides of the housing. For instance, as shown, the first access opening 13a is located adjacent the front side 12d while the second access opening 13b is located adjacent an opposite rear side 12e of the housing 12. As shown, the access openings 13a, 13b can be substantially the same size and aligned with one another such that the interior area 13 forms a through tunnel from the first access opening 13a to the second access opening 13b.

The dishwasher 10 can further include a door associated with each access opening to selectively close the respective access opening. As shown, the dishwasher 10 can include a first door 14 attached with respect to the housing 12 and configured to selectively close the first access opening 13a. Likewise, the dishwasher 10 can include a second door 16 attached with respect to the housing 12 and configured to selectively close the second access opening 13b. Dishwasher doors may comprise a wide variety of structures configured to selectively close the respective access opening. For instance, at least one or all of the doors can comprise one or more of a translational, rotational and/or pivotal configuration to selectively close the access opening. In the illustrated example, the first and second door 14, 16 are each pivotally attached with respect to the housing 12 and configured to selectively close the respective access opening by pivoting with respect to the housing.

Various door configurations may be used for doors that are pivotally attached with respect to the housing 12. Although not shown, example configurations can include one or more doors that are configured to pivot about a vertical axis with respect to the housing. Alternatively, or in addition, example configurations can include one or more doors that are configured to pivot about a horizontal axis. For example, as shown in the drawings, the first door 14 is configured to pivot about a first horizontal axis 14a while the second door 16 is configured to pivot about a second horizontal axis 16a. The first and second horizontal axis, if provided, can be located at an angle with respect to one another or can be substantially parallel with respect to one another. For instance, the illustrated first horizontal axis 14a is substantially parallel with respect to the second horizontal axis 16a. Still further, the first and second horizontal axis may or may not extend along a common plane. For example, as shown, the first and second horizontal axis 14a, 16a extend along a common plane that is configured to be substantially parallel with respect to an underlying support surface for the dishwasher. Although not shown, if the axes extend along a common plane, the common plane may be oriented such that the common plane is not parallel with respect to the underlying support surface. Such an example may arise, for instance, if the first horizontal axis and second horizontal axis are located at different elevations with respect to the underlying support surface.

Providing doors that pivot about a horizontal axis can facilitate loading of dishware into the interior area 13 of the housing 12. For example, as shown, the first door 14 can pivot in a first pivot direction 17a about the first axis 14a from a closed orientation to an open orientation to permit loading of dishware into the interior area 13 by way of the first access opening 13a. Likewise, the second door 16 can pivot in a second pivot direction 17b about the second axis 16a from a closed orientation to an open orientation to permit loading of dishware into the interior area 13 by way of the second access opening 13b. As further shown, the first pivot direction 17a is opposite the second pivot direction 17b. Although not shown, the first and second door can both pivot in other different directions or in the same direction from the closed orientation to the open orientation. Moreover, one or both of the axes may be located at an upper portion and/or a lower portion of the dishwasher apparatus. For instance, as shown, the both the first axis 14a and second axis 16a can be located adjacent a lower portion of the dishwasher 10 such that each door can extend substantially perpendicular from the lower portion of the housing 12 in the open orientation. Providing doors that open in such a manner can facilitate support of the lower rack and/or act as a guard to collect debris and/or fluid falling towards the underlying support surface as dishware is loaded into the interior area of the housing.

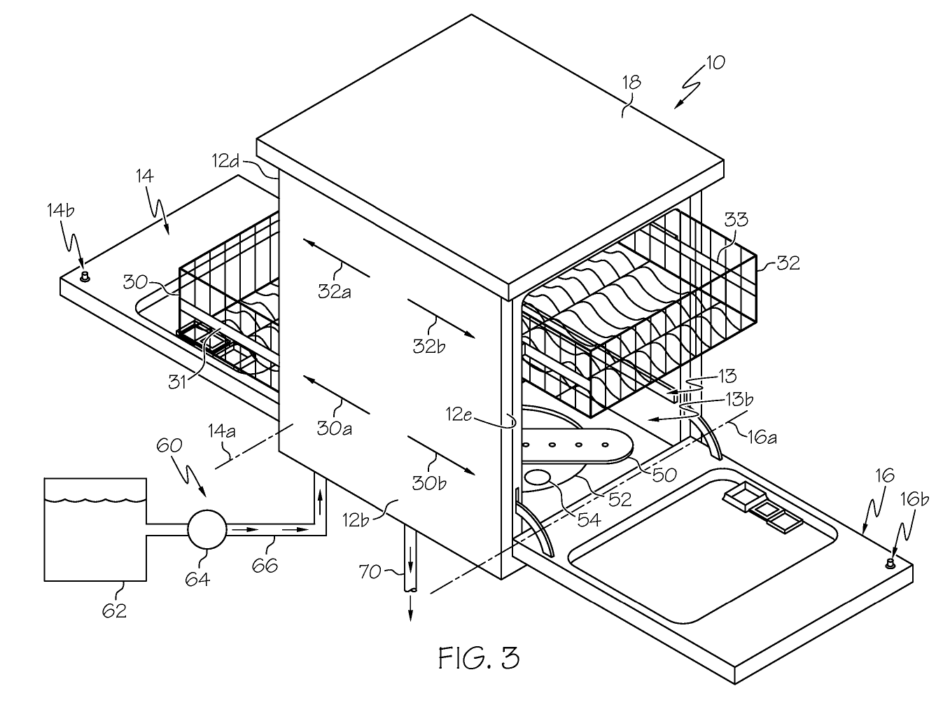

Although not shown, doors may be configured to be in a substantially noncoplanar relationship in an open orientation. For instance, although not shown, the first and second door may be configured to extend substantially parallel along respective planes that are spaced from one another when each door is in an open orientation. Such a configuration may result, for example, if the first horizontal axis and the second horizontal axis are located at different elevations with respect to the underlying support surface. In further examples, a plurality of the doors can be configured to be substantially coplanar in an open orientation. For instance, as shown in FIG. 3, the first and second doors 14, 16 can be arranged in a substantially coplanar relationship when both of the doors or positioned in an open orientation with respect to the housing. Providing both doors in a substantially coplanar relationship can provide a similar loading configuration at each respective access opening. Furthermore, a coplanar relationship may allow a dishwasher rack to be alternatively moved through the first and second access openings when moving the rack from a retracted position to an extended position.

Dishwashers in accordance with aspects of the present invention may include a sensing apparatus configured to sense a closed orientation of the first and second door with respect to the housing. In one example, each door can be associated with a sensor configured to sense when each respective door are positioned in the closed orientation. The sensor can include part of the door or may be incorporated in one or more other areas of the dishwasher in further examples. Many types of sensors may be used in accordance with aspects of the present invention. For example, laser sensors, infrared sensors or other proximity sensors may be used. In one example, as shown, each door 14, 16 can be provided with a sensor 14a, 16a, such as a push-button switch, configured to sense a closed orientation of the respective door with respect to the housing. The sensing apparatus can be beneficial for providing a lock-out aspect to prevent operation of the dishwasher when one of the doors is open. For example, if provided, the dishwasher 10 can be configured (e.g., with a control mechanism) to conduct a dishwashing operation (e.g., one or more of a plurality of dishwashing operations) only when the sensing apparatus indicates that both the first and second door 14, 16 are position in the closed orientation with respect to the housing. Providing a lock-out aspect can prevent inadvertent activation of one or more dishwashing operations while one of the doors is opened.

The dishwasher 10 may or may not include at least one dishwasher rack. For instance, concepts of the present invention may be incorporated in embodiments without racks. For example, the interior of the housing may be designed to receive dishware without the use of a rack. In further examples, at least one dishwasher rack may be provided to facilitate loading of dishware and/or supporting of dishware within the interior area of the housing during various dishwashing cycles (e.g., during wash, rinse and/or drying cycles). In the illustrated example, the dishwasher includes a first dishwasher rack 30 and a second dishwasher rack 32 although a single or more than two racks may be employed in further examples. The at least one dishwasher rack can be removably received within the interior area. For example, the dishwasher rack may be designed to be removed from the interior area and placed on a counter surface or other work area. The dishwasher rack can then be loaded and then placed back into the interior area. Alternatively, the at least one dishwasher rack can be fixedly attached with respect to the interior area of the housing. For instance, one or more racks may be attached with respect to the interior area so that they are immobile such that they do not extend outwardly from the interior area of the housing.

In still further examples, the dishwasher can include at least one dishwasher rack configured to be moved between a retracted position wherein the rack is located within the interior area and an extended position wherein at least a portion of the rack is located outside of the interior area. In such examples, the portion of the rack can be configured to be moved through at least one of the first and second access openings when moving the rack from the retracted position to the extended position. Embodiments of the present invention can include a rack slide assembly or other guide arrangement to facilitate pulling of the corresponding rack from the corresponding side of the dishwasher 10. Moreover, the rack slide assembly or other guide arrangement can be adapted to prevent over extension of the rack from at least one side of the dishwasher. Furthermore, the rack slide assembly or other guide arrangement can also be adapted to prevent over extension of the rack from both sides of the dishwasher. Example embodiments might include a rack slide assembly or other guide arrangement that includes one or more stop features to prevent over extension in each direction.

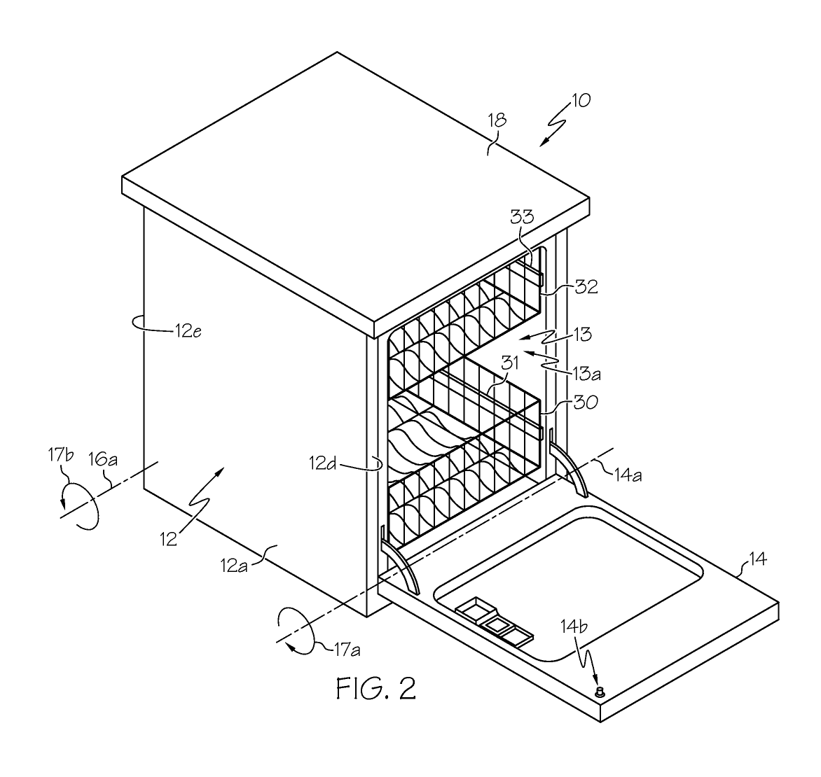

One or more of the dishwasher racks may have wheels configured to allow portions of the rack to be pulled from a retracted position to an extended position. In such examples, the wheels may be designed to ride on rails formed or mounted with respect to the sides of the interior area of the housing. The wheels can also be configured to ride on an upwardly facing surface of an open dishwasher door as the rack is pulled to the extended position. In addition or alternatively, one or more of the dishwasher racks can include a slide bracket assembly. For example, as shown, the first dishwasher rack 30 can include a first slide bracket assembly 31 and the second dishwasher rack 32 can include a second slide bracket assembly 33. As shown in FIG. 2, the first and second slide bracket assemblies 31, 33 can allow each corresponding dishwasher rack 30, 32 to be supported within the interior area 13 of the housing 12. The first and second dishwasher racks can be arranged in different ways within the interior area when the racks are in the retracted position. For instance, as shown in FIG. 2, the first dishwasher rack 30 can be configured to be positioned below the second dishwasher rack 32 when the first and second dishwasher racks 30, 32 are oriented in the retracted position. Moreover, the first and second dishwasher racks 30, 32 are substantially horizontal in the retracted position although, in further examples, one or more of the racks may be nonhorizontally disposed in the retracted position.

Each dishwasher rack 30, 32 can be moved from the retracted position (see FIG. 2) to an extended position wherein at least a portion of the rack 30, 32 is located outside of the interior area 13. The portion of the rack can be configured to be moved through at least one of the first and second access openings 13a, 13b when moving the respective rack 30, 32 from the retracted position to the extended position. For example, as shown in FIG. 3, the first rack 30 can be moved along direction 30a such that a portion of the first rack 30 is moved through the first access opening 13a when moving the first rack 30 from the retracted position shown in FIG. 2 to the extended position shown in FIG. 3. In addition or alternatively, the first rack 30 can be moved along direction 30b such that a portion of the first rack 30 is moved through the second access opening 13b when moving the first rack 30 from the retracted position shown in FIG. 2 to the extended position. Similarly, as shown in FIG. 3, the second rack 32 can be moved along direction 32b such that a portion of the second rack 32 is moved through the second access opening 13b when moving the second rack 32 from the retracted position shown in FIG. 2 to the extended position shown in FIG. 3. In addition, or alternatively, the second rack 32 can be moved along direction 32a such that a portion of the second rack 32 is moved through the first access opening 13a when moving the second rack 32 from the retracted position shown in FIG. 2 to the extended position. Moreover, the first and second dishwasher racks 30, 32 are substantially horizontal in the extended position although, in further examples, one or more of the racks may be nonhorizontally disposed in the extended position.

Still further, one or all of the racks may only extend in a single direction. For example, the upper and lower rack may only be adapted to extend from one side of the dishwasher. Alternatively, as discussed above, it is apparent that portions of one or more of the dishwasher racks 30, 32 may be configured to be moved through one or both of the first and second access openings 13a, 13b when moving the respective rack from the retracted position to the extended position. Permitting alternative moving of one or both of the racks through the first and second access openings 13a, 13b when moving the rack from the retracted position to the extended position can allow alternative loading of the dishwasher rack from a position adjacent each access opening.

One or more of the racks may include a stop mechanism to limit the extent to which the rack may be pulled with respect to the interior area of the housing. In embodiments where the rack may be pulled on opposite directions, the extendable racks may be designed to prevent over extension with respect to the interior area in both directions. For example, the racks may include one or more stop mechanisms adapted to limit the extent to which the rack may be pulled with respect to the interior surface from each side of the dishwasher.

The first and second slide bracket assemblies 31, 33 can be configured to permit alternative movement of the racks. In addition, one or both of the slide bracket assemblies 31, 33 can include the stop mechanism, such as one or more stops, to inhibit overextension of the respective rack from the interior area 13 of the housing 12. The slide bracket assemblies 31, 33 can also be configured to prevent extension in one direction. For instance, one or both of the slide bracket assemblies 31, 33 may include a device configured to allow a user to select whether the corresponding dishwasher 30, 32 may be extended in the first direction 30a, 32a, the second direction 30b, 32b, or alternatively in either the first or second direction.

Providing doors that open such that they extend from a lower portion of the dishwasher can also inhibit or prevent contamination the floor surrounding the dishwasher 10 from debris or fluid that might fall from loaded dishware being supported in one or more of the dishwasher racks 30, 32. For example, as shown in FIG. 3, first rack 30 can be pulled in direction 30a from the interior area 13 and thereafter loaded with dishware. Any debris or liquid falling from the loaded dishware will be collected by the underlying first door 14. Similarly, the first rack 30 can be pulled from the interior area 13 in an opposite direction 30b and thereafter loaded with dishware. Any debris or liquid would similarly fall from the loaded dishware to the underlying second door 16. Likewise, as shown in FIG. 3, second dishwasher rack 32 can be pulled in direction 32b from the interior area 13 and thereafter loaded with dishware. Any debris or liquid falling from the loaded dishware will be collected by the underlying second door 16. Similarly, the second dishwasher rack 32 can be pulled from the interior area 13 in an opposite direction 32a and thereafter loaded with dishware. Any debris or liquid would similarly fall from the loaded dishware to the underlying first door 14.

Racks of example dishwashers, if provided, can be attached or removable from the interior area. For example, one or more of the racks may be movably fixed with respect to the housing while one or more additional racks may be removable from the housing. For example, the second rack may be movably fixed with respect to the housing to permit extension of the rack with respect to the interior area, for example from either side of the dishwasher, while including features to prevent inadvertent complete removal from the dishwasher. At the same time, the first rack may include wheels to permit the lower rack to be rolled with respect to the housing to permit extension of the rack with respect to the interior area, for example from either side of the dishwasher, while allowing complete removal from the dishwasher.

As shown in FIG. 1, the first door 14 includes a set of operational controls 20 adapted to set and control the dishwashing function of the dishwasher 10. While the operational controls 20 are indicated as part of the first door 14, the operational controls can also be provided adjacent the first door. Alternatively, second door 16 may include or be provided with the operational controls. Still further, the first and second door 14, 16 may each be provided with a set of controls adapted to set and control the dishwashing function.

As shown in FIGS. 1-3, the dishwashers of the present invention can be designed as an undercounter dishwasher 10. As shown, for example, the undercounter dishwasher may be provided with a counter surface 18 mounted with respect to an upper surface 12c of the housing 12.

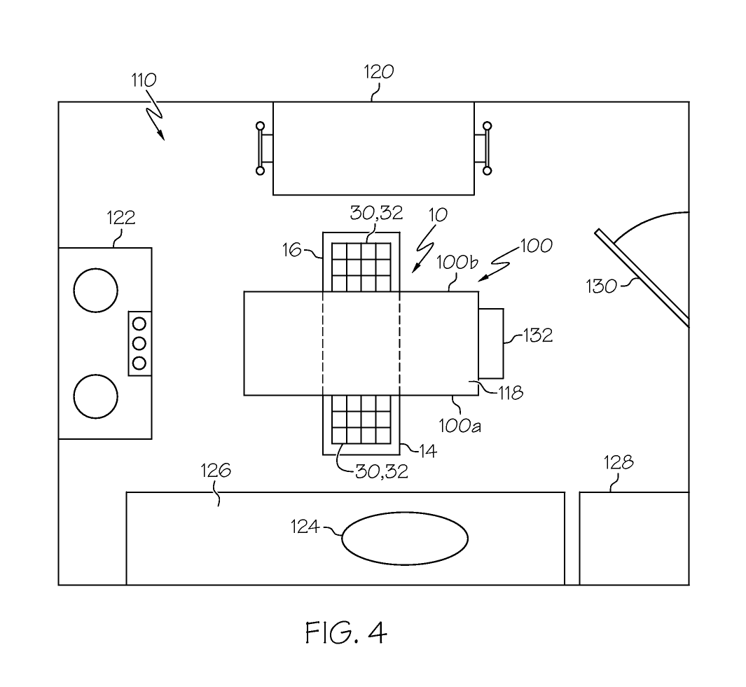

It is also contemplated, that dishwashers in accordance with the present invention may be incorporated as part of a workstation. For example, as shown in FIG. 4, the dishwasher 10 may be incorporated as part of an island workstation 100 configured to be positioned within an area of a workroom 110. As shown, the dishwasher 10 can be incorporated in the workstation such that a counter surface 118 of the island workstation 100 is positioned above the dishwasher 10. FIG. 4 further illustrates just one example schematic layout of a workroom incorporating the island workstation 100. As shown, the schematic layout may include a conventional stove 122 and/or refrigerator 128 and a door 130 for entry into the workroom (e.g., kitchen). A trash can 132 can be located adjacent the island workstation 100 to allow easy access from a first side 100a or a second side 100b of the island workstation 100. Moreover, the island workstation 100 can be ergonomically arranged between a dining table 120 and a counter surface 126 with corresponding basin 124. In use, an individual may easily unload dishes from the table 120 to either the counter surface 118 of the island workstation 100 or the counter surface 126 associated with the basin 124. The individual may further load dishware from one of the counter surfaces 118, 126 into one or both of the dishwasher racks 30, 32 that have been pulled from the first access opening 13a. In addition, or alternatively, the individual may load dishware from the counter surface 118 of the island workstation 100 or directly from the dining table 120 into one or both of the dishwasher racks 30, 32 that have been pulled from the second access opening 13b.

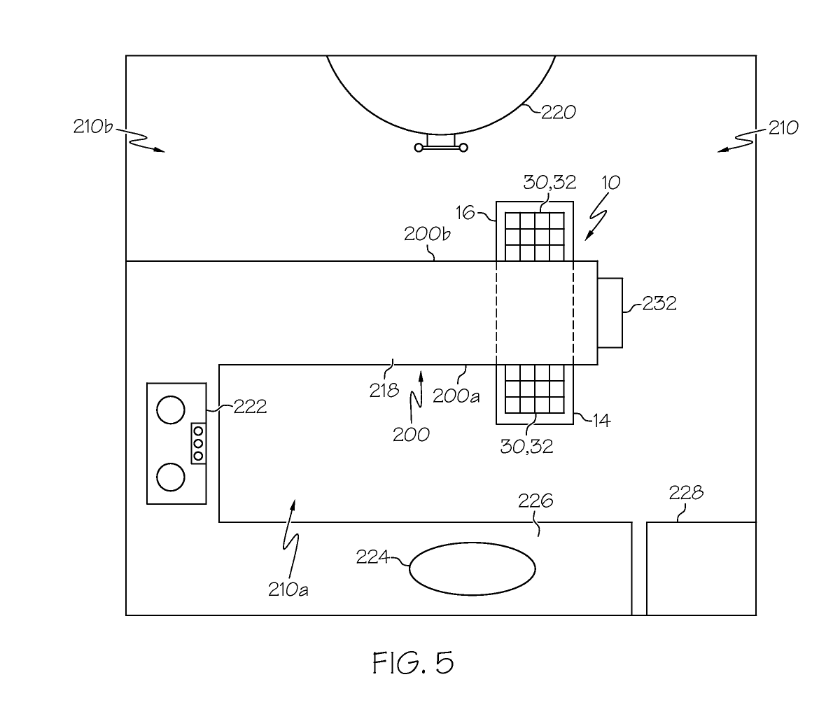

As shown in FIG. 5, the dishwasher 10 may also be incorporated as part of a peninsula workstation 200 configured extend within an area of a workroom 210. As shown, the dishwasher 10 can be incorporated in the workstation such that a counter surface 218 of the peninsula workstation 200 is positioned above the dishwasher 10. FIG. 5 further illustrates just one example schematic layout of a workroom incorporating the peninsula workstation 200. As shown, the schematic layout may include a conventional stove 222 and/or refrigerator 228 typically associated with a kitchen area 210a of the workroom 210. A trash can 232 can be located adjacent the peninsula workstation 200 to allow easy access from a first side 200a or a second side 200b of the peninsula workstation 200. The peninsula workstation 200 can be ergonomically arranged to divide the workroom 210 into the kitchen area 210a and a dining room area 210b. In use, an individual may easily unload dishes from a dining table 220 to either the counter surface 218 of the peninsula workstation 200 or a counter surface 226 associated with a basin 224. The individual may further load dishware from one of the counter surfaces 218, 226 into one or both of the dishwasher racks 30, 32 that have been pulled from the first access opening 13a. In addition, or alternatively, the individual may load dishware from the counter surface 218 of the peninsula workstation 200 or directly from the dining table 220 into one or both of the dishwasher racks 30, 32 that have been pulled from the second access opening 13b.

Although not shown, the dishwasher 10 may also be mounted in a wall of a room to provide access to the dishwasher from two living areas having the wall as a common boundary therebetween. Although not necessary, the dishwasher 10 might be mounted adjacent an open window in a wall between two living areas. For instance, an open window (with or without a counter) may provide access and/or viewing between the kitchen and the dining room, wherein dishware and other items may be loaded either from the kitchen or from the dining room. Providing access to the dishwasher from the dining room can allow loading of dishware directly into the dishwasher without leaving the dining room.

As shown schematically in FIG. 3, the dishwasher 10 may also include a garbage disposal unit 54 therein to reduce the necessity of pre-rinsing or pre-cleaning the dishware prior to loading in the dishwasher. A garbage disposal option for a dishwasher may be useful in applications where pre-rinsing or pre-cleaning is difficult when loading from one side of the dishwasher.

Referencing FIGS. 2 and 3, in use, an individual may load the dishwasher 10 by first opening one or both of the doors 14, 16. Next, one or both of the dishwasher racks 30, 32 may be extended from the first or second access opening 13a, 13b. Once loaded, the dishwasher racks 30, 32 may be moved to the retracted position as shown in FIG. 2. The first and second door 14, 16 may then be moved to the closed position and the individual may use the operational controls 20 to initiate the dishwashing operation. Once the dishwashing operation is initiated by the individual, at least one dishwashing operation begins only when the sensors 14b, 16b indicate that both the first and second door 14, 16 are positioned in the closed orientation. The dishwashing operation can include providing the dishwasher 10 with water by way of a water supply system 60. One example water supply system 60 can include a water source 62 in communication with the interior area 13 of the dishwasher 10 by way of a conduit 66. An optional water pump 64 can be configured to circulate water through the conduit 66 from the water source 62 to the interior area 13. A spray apparatus 50 then rotates and sprays water to clean dishware within the interior area 13 of the housing 12. The water can then be subsequently drained from a sump 52 through drain conduit 70. If provided with a garbage disposal 54, the disposal can be initiated as the water is drained from the interior area 13. Further dishwashing operations may be conducted to provide optimum cleaning of dishware within the dishwasher 10. The internal hydraulics of the dishwasher may also be adjusted to accommodate the doors of the dishwasher to prevent obstruction from either side of the dishwasher.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A dishwasher comprising:
a housing at least partially defining an interior area configured to receive dishware, the interior area including a first access opening and a second access opening;
a first door pivotally attached with respect to the housing and configured to selectively close the first access opening; and
a second door pivotally attached with respect to the housing and configured to selectively close the second access opening.

2. The dishwasher of claim 1, wherein the first door and the second door are each configured to pivot in opposite directions with respect to the housing.

3. The dishwasher of claim 1, wherein the first door and the second door are each configured to be substantially coplanar when the first and second doors are both positioned in an open orientation with respect to the housing.

4. The dishwasher of claim 1, further comprising a sensing apparatus configured to sense a closed orientation of the first and second door with respect to the housing, wherein the dishwasher is configured to conduct a dishwashing operation only when the sensing apparatus indicates that both the first and second door are positioned in the closed orientation.

5. The dishwasher of claim 1, wherein the first and second access openings are located at different sides of the housing.

6. The dishwasher of claim 5, wherein the different sides comprise opposite sides of the housing.

7. The dishwasher of claim 1, further comprising at least one dishwasher rack configured to be moved between a retracted position wherein the rack is located within the interior area, and an extended position wherein at least a portion of the rack is located outside of the interior area, wherein the portion of the rack is configured to be moved through at least one of the first and second access openings when moving the rack from the retracted position to the extended position.

8. The dishwasher of claim 7, wherein the portion of the rack is configured to be alternatively moved through the first and second access openings when moving the rack from the retracted position to the extended position.

9. The dishwasher of claim 7, wherein the at least one dishwasher rack comprises a first and second dishwasher rack.

10. The dishwasher of claim 9, wherein the portion of the first dishwasher rack and the portion of the second dishwasher rack are each configured to be alternatively moved through the first and second access openings when moving the respective first and second rack from the retracted position to the extended position.

11. The dishwasher of claim 9, wherein the first dishwasher rack is configured to be positioned below the second dishwasher rack when the first and second dishwasher racks are oriented in the retracted position.

12. A dishwasher comprising:
a housing at least partially defining an interior area configured to receive dishware, the interior area including a first access opening and a second access opening, wherein the first and second access openings are located at opposite sides of the housing;
a first door pivotally attached with respect to the housing and configured to selectively close the first access opening;
a second door pivotally attached with respect to the housing and configured to selectively close the second access opening, wherein the first door and the second door are each configured to pivot in opposite directions with respect to the housing; and
at least one dishwasher rack configured to be moved between a retracted position wherein the rack is located within the interior area, and an extended position wherein at least a portion of the rack is located outside of the interior area, wherein the portion of the rack is configured to be moved through at least one of the first and second access openings when moving the rack from the retracted position to the extended position.

13. The dishwasher of claim 12, further comprising a sensing apparatus configured to sense a closed orientation of the first and second door with respect to the housing, wherein the dishwasher is configured to conduct a dishwashing operation only when the sensing apparatus indicates that both the first and second door are positioned in the closed orientation.

14. The dishwasher of claim 12, wherein the portion of the rack is configured to be alternatively moved through the first and second access openings when moving the rack from the retracted position to the extended position.

15. The dishwasher of claim 12, wherein the first door and the second door are further configured to be substantially coplanar when the first and second doors are both positioned in an open orientation with respect to the housing.

16. A workstation comprising:
an undercounter dishwasher including a housing at least partially defining an interior area configured to receive dishware, the interior area including a first access opening and a second access opening, a first door configured to selectively close the first access opening, and a second door configured to selectively close the second access opening, at least one dishwasher rack configured to be moved between a retracted position wherein the rack is located within the interior area, and an extended position wherein at least a portion of the rack is located outside of the interior area, wherein the portion of the rack is configured to be moved through at least one of the first and second access openings when moving the rack from the retracted position to the extended position; and
a counter surface positioned above the dishwasher.

17. The workstation of claim 16, wherein the first and second access openings are located at opposite sides of the workstation.

18. The workstation of claim 16, wherein the workstation comprises an island configured to be positioned within an area of a workroom.

19. The workstation of claim 16, wherein the first door and the second door are each pivotally attached with respect to the housing.

20. The workstation of claim 19, wherein the first door and the second door are each configured to pivot in opposite directions with respect to the housing and are configured to be substantially coplanar when the first and second doors are both positioned in an open orientation with respect to the housing, and wherein the first and second door are each substantially parallel with respect to the counter surface when the first and second doors are both in the open orientation.
